(19) United States
(12) Patent Application Publication
(10) Pub. No.: US 2006/0198557 A1
(43) Pub. Date: Sep. 7, 2006

(54) Fragile audio watermark related to a buried data channel

(76) Inventors: Leon Maria Van De Kerkhof, Eindhoven (NL); Arnoldus Werner Johannes Oomen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/551,973

(22) PCT Filed: Mar. 31, 2004
(86) PCT No.: PCT/IB04/50367

§ 371 Date: Oct. 5, 2005

(30) Foreign Application Priority Data
Apr. 8, 2003 (EP) 03100946.7

(51) Int. Cl. G06K 9/40

(52) U.S. Cl. 382/254

(57) ABSTRACT

The present invention relates to methods, devices, a signal and recorded medium relating to a fragile watermark (WM) in a media signal. According to the invention a fragile watermark is provided in or in coding related to a buried data channel (40, 42, 44, 46) provided in the audio samples of the media signal, In this way the fragile watermark can be made to be very complex and still remain imperceptible to a user.

### TECHNICAL FIELD

The present invention generally relates to the field of consumer electronics and more particularly to the protection of copy-protected content material.

### DESCRIPTION OF RELATED ART

The illicit distribution of copyright material deprives the holder of the copyright legitimate royalties for this material, and could provide the supplier of this illicitly distributed material with gains that encourages continued illicit distributions. In light of the ease of transfer provided by the Internet, content material that is intended to be copyright protected, such as artistic renderings or other material having limited distribution rights are susceptible to wide-scale illicit distribution. The MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus a malicious party could read songs from an original and legitimate CD, encode the songs into MP3 format, and place the MP3 encoded song on the Internet for a wide-scale illegitimate distribution. Alternatively the malicious party could provide a direct dial-in service for downloading MP3 encoded song. The illicit copy of the MP3 encoded song can be subsequently rendered by software or hardware devices or can be decompressed and stored on a recordable CD for playback on a conventional CD player.

A number of techniques have been proposed for limiting the reproduction of copy-protected content material. The Secure Digital Music Initiative (SDMI) and others advocate the use of “digital watermarks” to identify authorised content material. It is known to use a combination of a robust and fragile watermark for copy protection. A robust watermark is expected to survive a lossy reproduction, while a fragile watermark is one that is expected to be corrupted or even lost by a lossy reproduction or other illicit tampering. A robust watermark therefore indicates that the content material is copy protected and that a fragile watermark should be present in the material.

For instance WO-A-01/5975 describes such a use of robust and fragile watermarks. Here a data item, for example in the form of songs, is added to a data set. A binder creates a unique identifier for each section of the data set and an identifier for the entirety of the data set. The section identifier and the data set identifier are in one variation provided as a fragile and a robust watermark, respectively, although other variations based on these identifiers are also described.

WO-A-95/18523 describes the use of a buried data channel in the least significant bits of samples of coded sound. This is done for providing additional retrievable information related or non-related to the coded sound, such as additional comment for example displayable subtitles or text, an additional sound channel, multilingual speech service, Karaoke or video.

The normal way to combine watermarks with a buried data channel is to first insert the watermarks in the signal and thereafter to insert the buried data channel into the audio samples of the signal.

The amount of information available for a fragile watermark in audio applications is limited by the constraint that the watermark must be imperceptible in all cases. This limits the complexity of the fragile watermark, which can make it easier for a malicious user to insert a correct watermark to the detriment of the copyright owner.

There is therefore a need for a new way to provide a fragile watermark so that the fragile watermark can be made more complex while at the same time being kept imperceptible in a media signal.

### SUMMARY OF THE INVENTION

It is thus an object of the present invention to provide a fragile watermark so that the fragile watermark can be made more complex while at the same time being kept imperceptible in a media signal.

According to a first aspect of the present invention, this object is achieved by a method of adding a fragile watermark to a media signal comprising at least one set of audio samples of digital audio information, comprising the steps of:

providing a buried data channel in the audio samples of the media signal, and

providing a fragile watermark in at least some of the audio samples,

wherein the fragile watermark is provided in or in coding related to the buried data channel.

According to a second aspect of the present invention, this object is also achieved by a method of detecting a fragile watermark in a media signal comprising at least one set of audio samples of digital audio information, comprising the step of:

detecting the presence or absence of a correct fragile watermark in at least some of the audio samples,

wherein the fragile watermark if present is provided in or in coding related to an at least originally provided buried data channel in the audio samples.

According to a third aspect of the present invention, this object is furthermore achieved by a device for adding a fragile watermark to a media signal comprising at least one set of digital audio samples, comprising:

a digital media source input for receiving at least one set of digital audio samples,

a watermark forming unit for providing a fragile watermark for use in at least some of the audio samples, and

a buried data inserting unit arranged to provide a buried data channel in the audio samples of the media signal and to provide the fragile watermark in or in coding at least related to the buried data channel.

According to a fourth aspect of the present invention, this object is also achieved by a device for detecting a fragile watermark in a media signal comprising at least one set of digital audio samples, comprising:

a fragile watermark detector detecting the presence or absence of a correct fragile watermark in at least some of the audio samples,

wherein the fragile watermark if present is provided in or in coding related to an at least originally provided buried data channel.

According to a fifth aspect of the present invention, this object is also achieved by a media signal comprising at least one set of audio samples of digital audio information, comprising:

a fragile watermark in at least one of the audio samples,

wherein the fragile watermark is provided in or in coding related to an at least originally provided buried data channel.

According to a sixth aspect of the present invention, this object is also achieved by a recorded medium comprising a media signal including at least one set of audio samples of digital audio information, which signal comprises:

a fragile watermark in at least one of the audio samples,

wherein the fragile watermark is provided in or in coding related to an at least originally provided buried data channel.

Claims 2, 12 and 17 are directed towards having fragile watermarks in the buried data channel.

Claims 3, 13 and 18 are directed towards having check information in relation to the fragile watermark in the buried data channel.

Claims 4 and 19 are directed towards providing the check information as a one-way function or with a relation to a robust watermark.

Claims 5, 14 and 20 are directed towards having synchronisation and allocation information in the buried data channel.

Claims 6 and 21 are directed towards providing the fragile watermark as a frequency variation of the spectral shape of output audio samples having the buried data channel.

Claims 7 and 22 are directed towards providing the frequency variation by varying the spectral shape of dither inserted in the buried data channel.

Claims 9 and 24 are directed towards providing the frequency variation by varying the spectral shape of a noise shaped signal added to the audio samples.

The present invention has the advantage of enabling the provision of complex fragile watermarks in relation to a media signal having a number of audio samples, which watermark can occupy a lot of space and still not be noticeable to a user of the media signal.

The general idea behind the invention is thus to provide a fragile watermark in or in the coding of a buried data channel that is provided in the audio samples of a media signal.

The expression an at least originally provided buried data channel is intended to indicate an originally provided buried data channel which has been lost in different processing steps, like for instance after mild attacks such as digital-to-analog and analog-to-digital conversion.

These and other aspects of the invention will be apparent from and elucidated with reference to the embodiments described hereinafter.

### BRIEF DESCRIPTION OF THE DRAWINGS

The present invention will now be explained in more detail in relation to the enclosed drawings, where

FIG. 1 shows a block schematic of a device for providing and detecting a fragile watermark according to the invention,

FIG. 2 shows a block schematic of a device for inserting a watermark into the samples of a media signal according to a first embodiment of the invention,

FIG. 3 shows a block schematic of a unit for adding a fragile watermark to additional data for provision in a buried data channel,

FIG. 4 shows a signal according to the invention with a frame of a number of audio samples having a buried data channel,

FIG. 5 shows a block schematic of a device for detecting a fragile watermark according to the first embodiment of the invention,

FIG. 6 shows a flow chart of a method for providing a fragile watermark in relation to a buried data channel according to the invention,

FIG. 7 shows a flow chart of a method for detecting a fragile watermark in relation to a buried data channel according to the invention,

FIG. 8 shows a block schematic of a device for providing a fragile watermark in relation to a buried data channel according to a second embodiment of the invention,

FIG. 9 shows a block schematic of a device for providing a fragile watermark in relation to a buried data channel according to a third embodiment of the invention,

FIG. 10 shows a graph over varied spectral shapes for providing a fragile watermark used in the second and third embodiments,

FIG. 11 shows a block schematic of a device for detecting a fragile watermark according to the second and third embodiments of the invention, and

FIG. 12 shows an optical disc on which a media signal having the fragile watermark according to the invention is stored.

### DETAILED DESCRIPTION OF EMBODIMENTS

The present invention relates to the field of providing fragile watermarks in digital media signals having audio samples. The media signal is in the preferred embodiment an audio signal. It is however not limited to audio but can be applied for other media signals like for instance video when including audio samples.

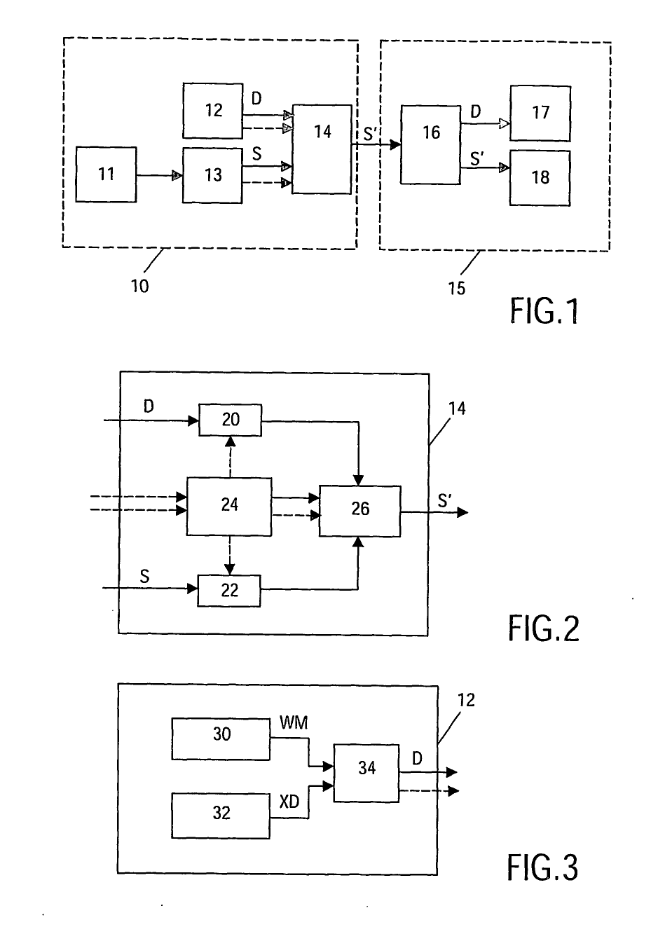

FIG. 1 shows a block schematic of a device according to the invention. The device includes a first device 10 on a sender side for adding a fragile watermark to the audio samples of the media signal and a second device 15 on a receiver side for detecting a fragile watermark in the audio samples of the media signal. The first device 10 includes an audio sample source 11, including a number of audio samples in the form of PCM (Pulse Code Modulation) samples, for instance in one or more songs provided in a CD record. The audio signals here already have a robust watermark provided in them. The source 11 is connected to an audibility determination unit 13, which provides audibility thresholds for audio samples with a limited part of a number of samples like a frame containing 1152 samples. Unit 13 is connected to a buried data inserting unit 14 and provides the samples S as well as audibility threshold information (shown with a dashed line), which is used for determining the size of the buried data channel. The unit 14 thus has an input for receiving PCM samples S and an input for receiving the audibility threshold information. The buried data inserting unit 14 is also connected to a buried data providing unit 12, which provides data D to be buried to the inserting unit 14 as well as allocation information for identifying different types of data D (indicated with a dashed line). The buried data inserting unit 14 sets up a buried data channel in the audio samples S, the size of which is determined by the received audibility threshold information. The unit 14 also inserts a fragile watermark into the samples and transmits the modified samples S′ to the device 15 for detecting watermarks via a channel. The device 15 receives the PCM samples S′ having the buried data channel in a buried data extracting unit 16. The data D in the buried data channel is extracted and provided to a buried data processor 17. The received PCM samples S′ are also provided to an audio processor 18 and thus the buried data is kept in the samples even for the audio processor.

FIG. 2 shows a block schematic of the buried data inserting unit 14, which includes a first buffer 20 for receiving the data D to be inserted in the buried data channel and a second buffer 22 for receiving the PCM samples S. In the second buffer the PCM samples are quantized to samples of a smaller size in order to provide space for additional data D. The block also includes a control unit 24, which determines synchronisation and allocation information for the buried data channel based on the received audibility threshold information as well as based on information about data content to be provided in the buried data channel and received from the buried data providing unit 12. The control unit 24 provides the first and second buffers 20 and 22 with information about how many bits of each original PCM sample S are to include additional data. This determination is done dynamically for a number of blocks of samples based on the information from unit 13. The control unit 24 and the two buffers 20 and 22 are also connected to a combiner 26, in which the additional data is inserted in the least significant empty bits of the recoded PCM samples. The control unit 24 also forwards synchronisation and allocation information to the combiner 26 for inserting in the buried data channel.

FIG. 3 shows a block schematic of the buried data providing unit 12. Here a fragile watermark source 30 or a watermark forming unit providing a fragile watermark WM is connected to a data combiner 34 together with an additional data source 32 providing additional data XD. The combiner 34 combines these two pieces of information to form data D to be inserted into the buried data channel. The fragile watermark source 30 here provides the fragile watermark as a number of bits of a general random character according to known principles. The additional data can be in the form of additional comments such as displayable subtitles or text, an additional sound channel, multilingual speech service, Karaoke or video. The combiner also provides allocation information regarding which data is watermark and which is additional data to the control unit of the buried data insertion unit.

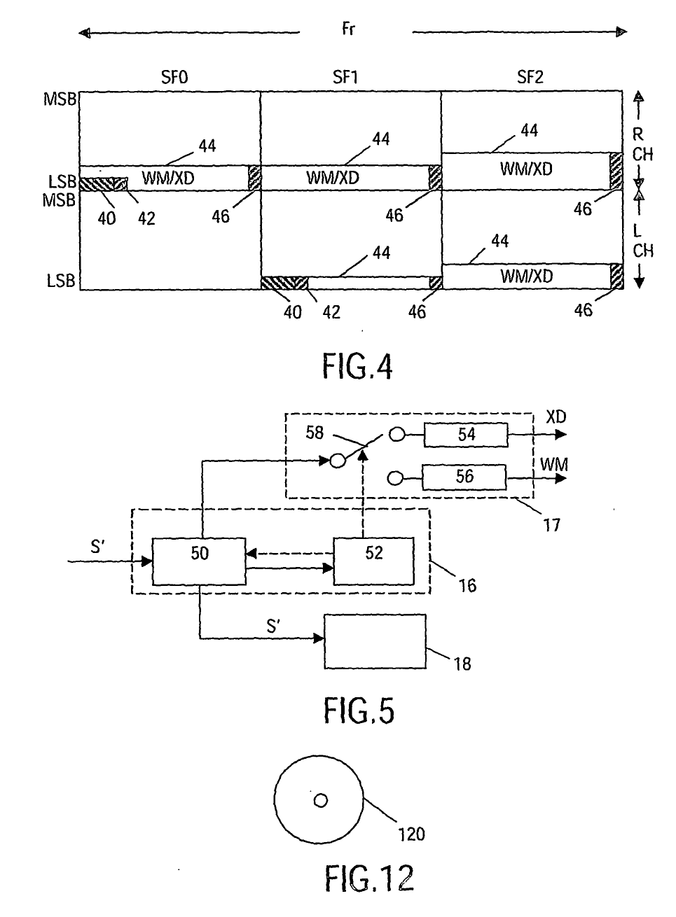

A CD audio signal normally comprises two channels a left and a right channel in which buried data can be inserted. FIG. 4 generally shows how to provide a buried data channel in both these channels. First of all the samples are divided into frames Fr, where a frame consists of 1152 PCM samples. Each frame Fr is then subdivided into three different subframes SF0, SF1 and SF2. Due to the perceptual properties of the buried data signal, it is always possible to provide the two least significant bits of each PCM sample as a buried data channel and therefore the two least significant bits can always be provided for allocation and synchronisation information, which is used for indicating the nature of the buried data payload. In FIG. 4 there is shown two channels a right and a left channel R CH and L CH for a frame Fr. A buried data channel is provided in each channel. The right channel R CH includes a buried data channel in all of its subframes, while the left channel L CH only includes a buried data channel in the second and third subframe SF1 and SF2. The first sample containing a buried channel always includes a field with synchronisation and allocation information 40, to which is appended a CRC-check 42. This part is provided in the part of the buried channel that is always available. This information thus indicates how big the buried data channel is and the positions of fragile watermark and additional data as well as if and in which samples a buried data channel is provided. Depending on the properties of the PCM samples, more or fewer bits can be provided for additional data, where the right channel R CH is shown having more such space in the first and second subframes SF0 and SF1, while the third subframe SF2 of this channel has an even higher capacity. The left channel L CH does not have any extra capacity in the second subframe SF1, while it has some more capacity in the third subframe SF2. The capacity is decided on a frame-by-frame basis through the previously mentioned audibility threshold information. The additional data 44 here includes a fragile watermark as well as other additional data intended to be processed on the receiver side. Each subframe including additional data is provided with a CRC check 46 at the end. This CRC check is based on the fragile watermark and is preferably provided as a one-way function or has some type of relation to the previously inserted robust watermark.

FIG. 5 shows a block schematic of a receiver or device for detecting watermarks receiving the PCM samples including the buried data channel. The buried data extracting unit 16 includes an input buffer 50, where the PCM samples S′ are received, a control unit 52, which extracts the synchronisation and allocation information from the buried data channel and provides the whole received PCM samples S′ to the audio processor 18 as well as extracted buried data to the buried data processor 17. The buried data processor 17 includes a fragile watermark detector 56 and an additional data processor 54 connected to the buffer 50 via a switch 58. The control unit 52 controls the switch 58 in dependence of the synchronisation and allocation information, i.e. the information in the synchronisation and allocation information that indicates what part is additional data and what part is a fragile watermark. The fragile watermark detector 56 checks the fragile watermark WM and the corresponding CRC code and indicates if the watermark is correct or false in dependence of these checks. The detection of a fragile watermark is of course made in relation to the detection of a corresponding robust watermark.

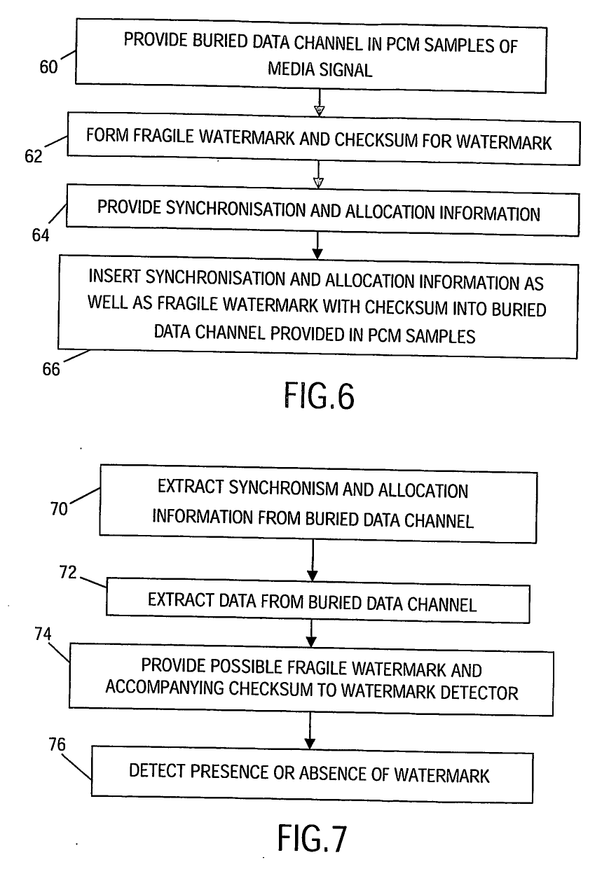

The method according to the invention will now be shortly described with reference to FIGS. 6 and 7, showing the method steps carried out on the sender and receiver sides.

First the buried data channel is provided in the PCM samples of the media signal, step 60. Thereafter a fragile watermark and a corresponding checksum for the watermark is generated, i.e. a CRC check, step 62. Synchronisation and allocation information is then provided, step 64. This synchronisation and allocation information is calculated on a frame-by-frame basis based on the properties of the PCM samples. The synchronisation and allocation information as well as fragile watermark with checksum and any possible additional information is provided in the buried data channel, step 66. The synchronisation and allocation information is here provided in the first subframe of each frame that includes a buried data channel, while all the other data is provided in all the subframes including a buried data channel. The watermark with checksum as well as any additional data is inserted in dependence of space available because of the sound quality of the samples.

On the receiving side synchronisation and allocation information is extracted from the buried data channel, step 70. Thereafter the data is extracted from the data channel based on this information, step 72. The possible watermark is then provided together with the accompanying check sum to the watermark detector, step 74, also here based on the synchronisation and allocation information. The original PCM samples are provided to the audio processor while the additional data is provided to the additional data processor. Thereafter the presence or absence of a fragile watermark is detected, step 76.

In the above-described first and preferred embodiment of the invention data was provided as regular bits in the data channel. Additional data was also provided. It should be realised that it is just as well possible to only provide the watermark in the channel without any additional data. The data in the buried data channel can also be provided in a randomised way using a randomising function. In this case the watermark is randomised, while the corresponding CRC check is not. After decoding the CRC check is used to provide the correct randomised version of the watermark, which is then checked for correctness in the watermark detector. It should furthermore be realised that the CRC-check of the fragile watermark might not be used. However, then there is a risk that a correct watermark might be hard to detect.

With the above-described preferred embodiment of the invention there is provided the possibility to include a fragile watermark occupying a large number of bits while at the same time keeping the fragile watermark non-perceptible for a user of the media signal. This means that a more complex watermark, which is less susceptible to malicious attacks, can be provided than before. However, it has a low resistance to mild attacks such as DA/AD conversion (digital to analogue to digital). The main reason for this is that the payload of the fragile watermark is written in the time domain. After re-sampling in the analogue domain, it is very unlikely that the exact payload can be retrieved. A second and a third embodiment of the invention solves this problem of providing a fragile watermark, which is robust to these types of mild attacks.

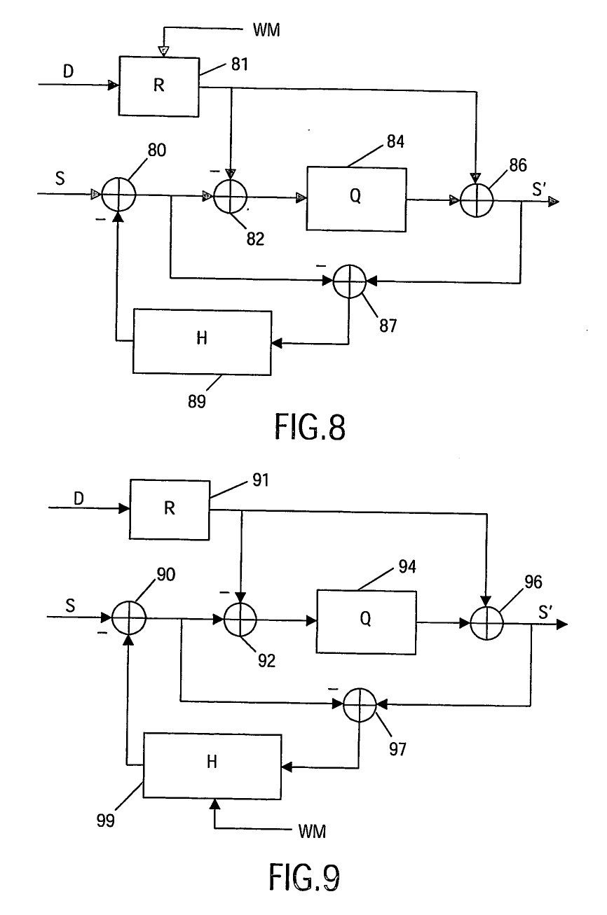

A variation of the buried data inserting unit according to a second embodiment is shown in a block schematic in FIG. 8. Here a fragile watermark is not inserted directly as a number of bits in the buried data channel, but another way of inserting a watermark is provided.

In FIG. 8 there is shown how additional data D for provision in a buried data channel is randomised by a randomising unit 81 using a randomising function R. The original PCM samples S are provided to a first subtracting unit 80, to which the output of a noise shaping unit 89 shaping noise with a function H is connected. The first subtracting unit 80 is connected to a second subtracting unit 82 to which the output of the randomising unit 81 is also connected. The second subtracting unit 82 is connected to a quantisation unit 84 having a quantisation function Q, where the output of the quantisation unit 84 is connected to an adding unit 86, to which adding unit 86 is also connected the output of the randomising unit 81. The adding unit 86 also provides an output signal S′. The output signal S′ is provided to the receiver side, but is also provided to a third subtracting unit 87, which is also connected to the first subtracting unit 80. The third subtracting unit 87 is furthermore connected to the input of the noise shaping unit 89. A watermark is here provided by influencing the randomising unit 81.

The functioning of the device in FIG. 8 is the following. Additional data D for a buried data channel is provided to the randomising unit 81, which randomises the additional data according to a reversible randomising function R, which additional data will make up a number of least significant bits of the audio samples. The randomisation can be provided through a CRC-circuitry comprising a tapped delay line and a number of exclusive—or units, which perform exclusive—or combinations on the delayed input data bits. These randomised least significant bits are thus provided in the form of dither and first subtracted from the PCM samples S. The resulting signal from the subtraction is then quantised in the quantisation unit 84 such that a number of least significant bits are discarded from the PCM samples. The number of bits discarded are, as mentioned before, determined dynamically by analysing the audibility threshold and in this case the masked error spectrum of the PCM samples. To this quantized signal is then added the additional data D in the form of the randomised least significant bits or dither, where the number of bits inserted are also determined by the dynamic analysis of the masked error spectrum. The result is provided as a signal S′ with the PCM samples including the buried data channel. The third subtracting unit 87 provides an error signal between the input PCM samples S and the output PCM samples S′, which is provided to the noise shaping unit 89. The noise shaping unit 89 is a noise shaping filter that shapes the white noise floor based on the error signal and subtracts it from the input signal S. The functioning of the device is described in more detail in WO-A-95/18523, which is herein incorporated by reference.

The watermark is added through varying the frequency spectrum of the dither. The fragile watermark is thus provided in the coding of the buried data channel. This is done through using a randomising function R that gives a non-flat spectrum. In this way the buried data can be retrieved. Alternatively it is possible to filter the dither through a filter where the coefficients have been chosen such that the high frequency spectrum of the dither is varied. This is however not preferred, since then the data is in most cases lost. The frequency spectrum of the dither is also combined with the desired masked error spectrum in order to provide information that is used for selecting the proper coefficients for the noise shaping unit 89.

FIG. 9 shows an alternative device for providing the fragile watermark in a block schematic of a third embodiment of the invention. In FIG. 9 there is shown how additional data is randomised by a randomising unit 91 using the same randomising function R. The original PCM samples S are provided to a first subtracting unit 90, to which the output of a noise shaping unit 99 shaping noise with a function H is connected. The first subtracting unit 90 is connected to a second subtracting unit 92 to which the output of the randomising unit 91 is also connected. The second subtracting unit 92 is connected to a quantisation unit 94 having a quantisation function Q, where the output of the quantisation unit 94 is connected to an adding unit 96, to which adding unit 96 is also connected the output of the randomising unit 91. The adding unit 96 also provides an output signal S′, which is provided to a third subtracting unit 97, which is also connected to the first subtracting unit 90. The third subtracting unit 97 is furthermore connected to the input of the noise shaping unit 99. A watermark is here provided by influencing the noise shaping unit 99.

The functioning of the device in FIG. 9 is essentially the same as the functioning of the device in FIG. 8. The difference is however that a fragile watermark is added through varying the frequency spectrum of the noise shaping unit 99. This is done through selecting the filter coefficients of the noise shaping unit 99 such that the frequency spectrum is varied.

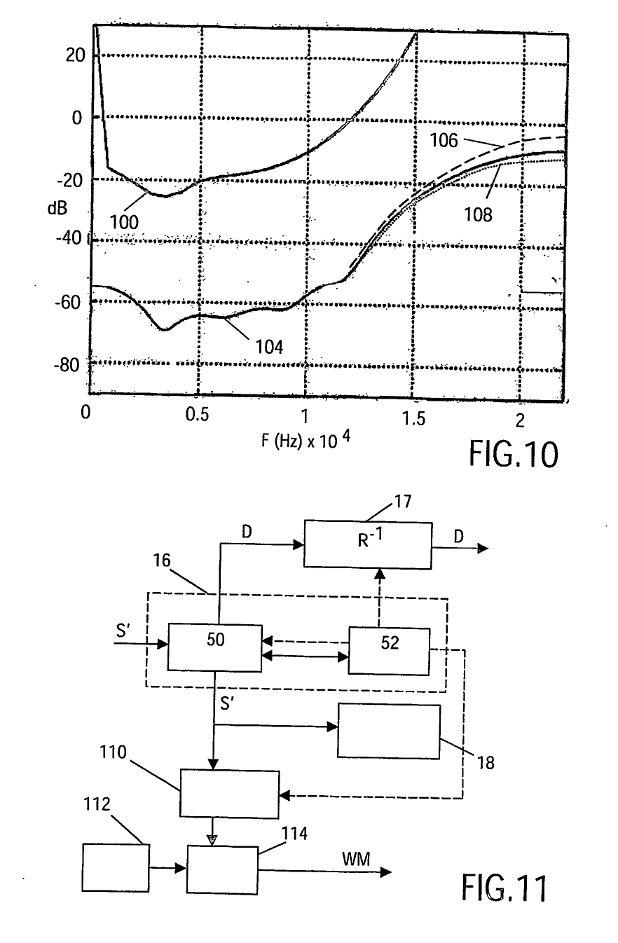

FIG. 10 shows a typical spectrum that has been changed according to either the second or third embodiment of the invention.

In FIG. 10 there are shown four different curves. A first curve 100 shows the masked error threshold of an audio sample, i.e. the audibility level as based on single frequencies for a human hearing system. In order to be non-perceptible the noise provided by the buried data channel and the noise from the noise shaping unit has to be well below this curve. A second curve 104 shows a typical frequency spectrum for noise added to audio samples based on added data and noise shaping using the noise shaping function. This curve corresponds to a buried data channel having two bits, which is the case when the input signal is silent. Both these curves 100 and 104 are shown with solid lines. Typical variations that are provided according to the invention is shown in a third and fourth curve 106 and 108, respectively. The third curve 106 is indicated with a dashed line and the fourth curve 108 is indicted with a dotted line. In the third curve 106, the high-frequency part of the spectrum has been modified so that this part of the curve rises somewhat more steeply than the normal second curve 104 and the fourth curve 108 rises less steeply than the normal second curve 104. The third and fourth curves can each correspond to the payload of a fragile watermark. This kind of variation is possible to detect in a detector.

FIG. 11 shows a block schematic of a suitable receiver for receiving a PCM sample with buried data. The receiver receives PCM samples having a fragile watermark inserted according to the second or third embodiments. As in FIG. 5, the buried data extracting unit 16 includes an input buffer 50, where the PCM samples are received, a control unit 52, which extracts the synchronisation and allocation information from the buried data channel and provides the whole received PCM samples S′ to the audio processor 18 as well as extracted buried data D to the buried data processor 17. The buried data processor applies a reverse coding function R⁻¹ in order to retrieve the buried additional data. The fragile watermark detector is however not provided in the buried data processor 17. There is a separate fragile watermark detector including a spectral shape determinator 110 connected to the input buffer 50 for receiving the received audio samples S′ and which also receives the synchronisation and allocation information from the control unit 52. Based on this information the determinator 110 determines the spectral shapes of audio samples indicated as including fragile watermarks. The shapes are then forwarded to a shape comparing unit 114, which is also connected to a spectral shape library 112, including different spectral shapes that can be present for a fragile watermark. Based on the shape comparisons the comparing unit provides an indication of presence or absence of the correct fragile watermark.

The spectral shape determinator would normally include a FFT (Fast Fourier Transform) function, which transforms a time dependent sample into the frequency domain, where the comparisons are then made.

Above was described a case where the PCM samples had not undergone any mild attacks. If they do, there would not be any buried data that would be possible to extract. In this case it is still possible to identify the fragile watermark, because the spectral shape variation is retained. However then the detector would not be able to receive the synchronisation and allocation information, which would be used for helping to identify where a fragile watermark is encoded. In that case synchronisation can be achieved in the detector by analysing the spectral shape on a finer temporal grid such that it can identify the time locations where the spectral shape changes.

As mentioned above, the fragile watermark is provided in relation to a media signal having a buried data channel provided in the audio samples. This signal can be stored on a storage medium, such as an optical disc. FIG. 12 shows one such disc 120.

The invention thus provided a way to provide complex fragile watermarks in relation to a media signal having a number of audio samples, which watermark can occupy a lot of space and still not be noticeable to a user of the media signal. In one variation of the invention the fragile watermark is also robust against mild attacks.

The invention can be varied in many ways. It should be realised that any suitable transmission channel can provide the channel between the sender and receiver side. The media signal can also be stored on a storage medium, such as a CD disc, which can then be provided to the receiving side in a suitable manner in order to provide the channel. There does also not have to be two channels of audio samples, i.e. left and right, but the invention can just as well be used using only one channel of audio samples.

The provision of synchronisation and allocation information does not have to be made on a frame-by-frame basis. As an alternative it is also possible to provide the synchronisation and allocation information on a subframe-by-subframe basis. The receiving device need not have to process the audio or extract the additional data. In its simplest form the receiving side only has the functionality to extract a fragile watermark in order to provide detection of it. The information about the payload in the buried data channel does not have to be provided from the buried data providing unit to the buried data inserting unit. This information can be known beforehand by the devices on the sender and receiver sides. It is also possible to provide this information in the buried data channel for extraction and processing in the buried data processor.

1. Method of adding a fragile watermark (WM) to a media signal (S) comprising at least one set of audio samples of digital audio information, comprising the steps of:
providing a buried data channel (40, 42, 44, 46) in the audio samples of the media signal, (step 60), and
providing a fragile watermark in at least some of the audio samples, (step 66), wherein the fragile watermark is provided in or in coding related to the buried data channel.

2. Method according to claim 1, wherein the step of providing a fragile watermark comprises inserting the fragile watermark in the buried data channel (44).

3. Method according to claim 2, further including the steps of generating check information (46) related to the fragile watermark, (step 62), and inserting the check information related to the fragile watermark into the buried data channel, (step 66).

4. Method according to claim 3, further including the step of generating the check as a one way function or with a relation to a robust watermark associated with the fragile watermark.

5. Method according to claim 1, further including the step of inserting synchronisation and allocation information (40) in the buried data channel, (step 66), which information enables extraction of data in the buried data channel.

6. Method according to claim 1, wherein the step of providing a fragile watermark comprises providing a frequency variation of the spectral shape of the output audio samples having the buried data channel.

7. Method according to claim 6, wherein the frequency variation is provided through varying the spectral shape of dither to be inserted in the buried data channel.

8. Method according to claim 7, further including the steps of combining the spectrum of the dither with a desired masked error spectrum for providing information for determining a noise shaped signal, providing said noise shaped signal and combining the noise shaped signal with the audio samples.

9. Method according to claim 6, wherein the frequency variation is provided through varying the spectral shape of a noise shaped signal and combining the processed noise shaped signal with the audio samples.

10. Method of detecting a fragile watermark (WM) in a media signal (S′) comprising at least one set of audio samples of digital audio information, comprising the step of:
detecting the presence or absence of a correct fragile watermark in at least some of the audio samples, (step 76),
wherein the fragile watermark if present is provided in or in coding related to an at least originally provided buried data channel (40, 42, 44, 46) in the audio samples.

11. Method according to claim 10, wherein the audio samples include a buried data channel and further comprising the step of extracting data from the buried data channel, (steps 70, 72).

12. Method according to claim 11, wherein the step of detecting a watermark comprises extracting the fragile watermark from the buried data channel (44).

13. Method according to claim 12, further including the step of extracting check information (46) relating to the fragile watermark and determining if the watermark is a correct watermark based on the check information.

14. Method according to claim 11, further comprising the step of extracting synchronisation and allocation information (40) from the buried data channel and extracting data and detecting fragile watermark based on this synchronisation and allocation information.

15. Method according to claim 10, wherein the fragile watermark is provided as a certain spectral variation of the audio samples of the media signal in relation to the originally provided buried data channel and further comprising the step of detecting the spectral shape of the audio samples in order to detect the presence or absence of a fragile watermark.

16. Device (10) for adding a fragile watermark (WM) to a media signal (S) comprising at least one set of digital audio samples, comprising:
a digital media source input for receiving at least one set of digital audio samples,
a watermark forming unit (30) for providing a fragile watermark for use in at least some of the audio samples, and
a buried data inserting unit (14) arranged to provide a buried data channel (40, 42, 44, 46) in the audio samples of the media signal and to provide the fragile watermark in or in coding at least related to the buried data channel.

17. Device according to claim 16, wherein the buried data inserting unit is arranged to insert the fragile watermark in the buried data channel (44).

18. Device according to claim 17, wherein the watermark forming unit is arranged to generate check information related to the fragile watermark and the buried data inserting unit is further arranged to insert said check information related to the fragile watermark into the buried channel (46).

19. Device according to claim 18, wherein the watermark forming unit is further arranged to generate the check as a one way function or with a relation to a robust watermark associated with the fragile watermark.

20. Device according to claim 16, wherein the buried data inserting unit is arranged to insert synchronisation and allocation information enabling extraction of data in the buried data channel (40).

21. Device according to claim 16, wherein the buried data inserting unit is arranged to provide the fragile watermark as a frequency variation of the spectral shape of the output audio samples having the buried data channel.

22. Device according to claim 21, wherein the buried data inserting unit comprises a randomising unit (81) for providing data in the buried data channel in the form of dither coded with a reversible coding function (R) and the buried data inserting unit is arranged to vary the spectral shape of the dither to be inserted in the buried data channel in order to provide a fragile watermark.

23. Device according to claim 22, wherein the buried data inserting unit further comprises a noise shaping unit (89) and is further arranged to combine the spectrum of the dither variation with a desired masked error spectrum and then provide this information to the noise shaping unit for forming a noise shaped signal for combining with the audio samples.

24. Device according to claim 21, wherein the buried data inserting unit further comprises a noise shaping unit (99) and is further arranged to vary the spectral shape of a noise shaped signal from the noise shaping unit and combine the processed noise shaped signal with the audio samples.

25. Device (15) for detecting a fragile watermark (WM) in a media signal (S′) comprising at least one set of digital audio samples, comprising:
a fragile watermark detector (56; 110, 112, 114) detecting the presence or absence of a correct fragile watermark in at least some of the audio samples,
wherein the fragile watermark if present is provided in or in coding related to an at least originally provided buried data channel (40, 42, 44, 46).

26. Device according to claim 25, further including a buried data extracting unit (16) extracting data in a buried data channel in the audio samples of the media signal.

27. Media signal (S′) comprising at least one set of audio samples of digital audio information, comprising:
a fragile watermark (WM) in at least one of the audio samples,
wherein the fragile watermark is provided in or in coding related to an at least originally provided buried data channel (40, 42, 44, 46).

28. Recorded medium (120) comprising a media signal (S′) including at least one set of audio samples of digital audio information, which signal comprises:
a fragile watermark (WM) in at least one of the audio samples,
wherein the fragile watermark is provided in or in coding related to an at least originally provided buried data channel (40, 42, 44, 46).
